(19) United States
(12) Patent Application Publication
(10) Pub. No.: US 2008/0314209 A1
(43) Pub. Date: Dec. 25, 2008

(54) Torque wrench with detection and display of torque

(76) Inventor: Chiang-Kao Chen, Hsin Tien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/230,196

(22) Filed: Aug. 26, 2008

(30) Foreign Application Priority Data
May 30, 2007 (TW) 096208868

(51) Int. Cl. B25B 23/144; B25B 13/06

(52) U.S. Cl. 81/479; 81/121.1

(57) ABSTRACT

A torque wrench includes a handle, a wrenching unit, at least one torque sensor, and a torque display unit. The handle has an end forming a connection portion. The wrenching unit has an end forming a fitting portion, which is connectable to the connection portion of the handle and releasably secured thereto by a bolt so that the wrenching unit can be selectively secured to the handle or released from the handle for replacement. The torque sensor is mounted to the handle to detect deformation of the handle and generate a detection signal when the wrenching unit applies a torque to a workpiece. The torque display unit is coupled to a joint between the handle and the wrenching unit and includes a display processing circuit that is connected to the torque sensor to receive the detection signal from the torque sensor and further process and display a torque reading corresponding to the detection signal so that the reading of an actual torque that the wrenching unit provides can be immediately displayed to thereby realize a wrench that is capable of replacement of different wrenching units and displaying of reading of torque.

### BACKGROUND OF THE INVENTION

1. Field of the Invention

The present invention relates to a torque wrench with detection and display of torque, and in particular to a torque wrench that is capable of replacement of wrench ends of different specifications and immediate display of torque applied.

2. The Related Arts

Torque wrenches have been widely used in assembling and repairing and other operations of mechanical devices or machines to tighten/loosen bolts. For mechanical devices of high precision, bolts are dismounted with a specific operation sequence and a particularly specified torque applied thereto. An improper operation may result in breaking of the thread of the bolt and even damage to the operation and/or precision of the mechanical devices. The conventional torque wrenches are incapable to detect and immediately display or illustrate the torque applied. Thus, the conventional torque wrenches do not allow a user to realize the level of the torque applied. The user must count on his or her own discretion to determine if the torque applied is of acceptable level. As a consequence, human error may occur frequently.

A torque detection device can be employed to detect the torque applied by a torque wrench, but the torque detection device is separate from the torque wrench. Combination and connection between the torque wrench and the torque detection device is difficult and is impractical for wrenching operation.

Thus, it is desired to have a torque wrench that overcomes the problems discussed above for the conventional torque wrenches.

### SUMMARY OF THE INVENTION

An objective of the present invention is to provide a torque wrench with detection and display of torque, wherein at least one torque sensor and a torque display unit are directly mounted between a handle and a wrenching unit to immediately display the reading of the torque that the wrench actually applies.

Another objective of the present invention is to provide a torque wrench comprising a handle and a wrenching unit that are releasably secured together by a bolt so as to allow for replacement of the wrenching unit.

To achieve the above discussed objectives, in accordance with the present invention, a torque wrench is provided, comprising a handle, a wrenching unit, at least one torque sensor, and a torque display unit. The handle has an end forming a connection portion. The wrenching unit has an end forming a fitting portion, which is connectable to the connection portion of the handle and releasably secured thereto by a bolt so that the wrenching unit can be selectively secured to the handle or released from the handle for replacement. The torque sensor is mounted to the handle to detect deformation of the handle and generate a detection signal when the wrenching unit applies a torque to a workpiece. The torque display unit is coupled to a joint between the handle and the wrenching unit and includes a display processing circuit that is connected to the torque sensor to receive the detection signal from the torque sensor and further process and display a torque reading corresponding to the detection signal so that the reading of an actual torque that the wrenching unit provides can be immediately displayed to thereby realize a wrench that is capable of displaying of reading of the torque that the wrench actually applies.

### BRIEF DESCRIPTION OF THE DRAWINGS

The present invention will be apparent to those skilled in the art by reading the following description of preferred embodiments thereof, with reference to the attached drawings, wherein:

FIG. 1 is a perspective view of a torque wrench constructed in accordance with a first embodiment of the present invention;

FIG. 2 is another perspective view of the torque wrench viewed from a different direction;

FIG. 3 is an exploded view of the torque wrench of the present invention;

FIG. 4 is a block diagram of a display control circuit of the torque wrench of the present invention; and

FIG. 5 is a perspective view of a torque wrench constructed in accordance with a second embodiment of the present invention.

### DETAILED DESCRIPTION OF THE PREFERRED EMBODIMENTS

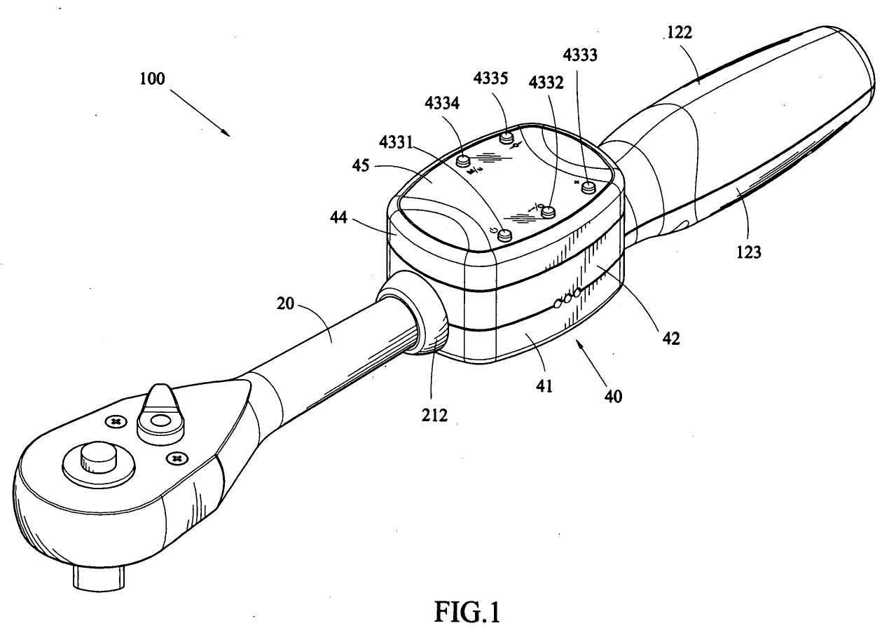

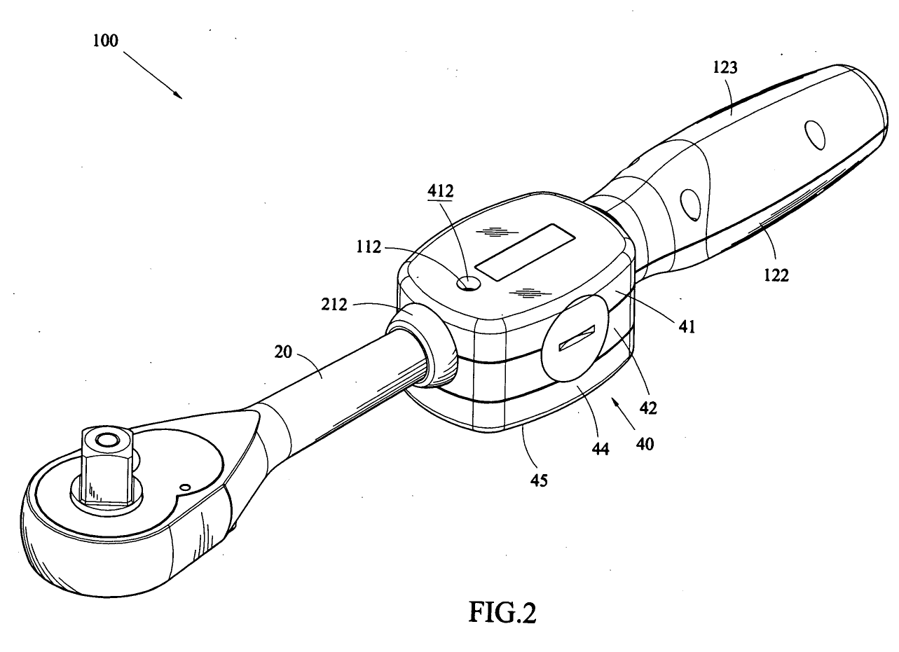

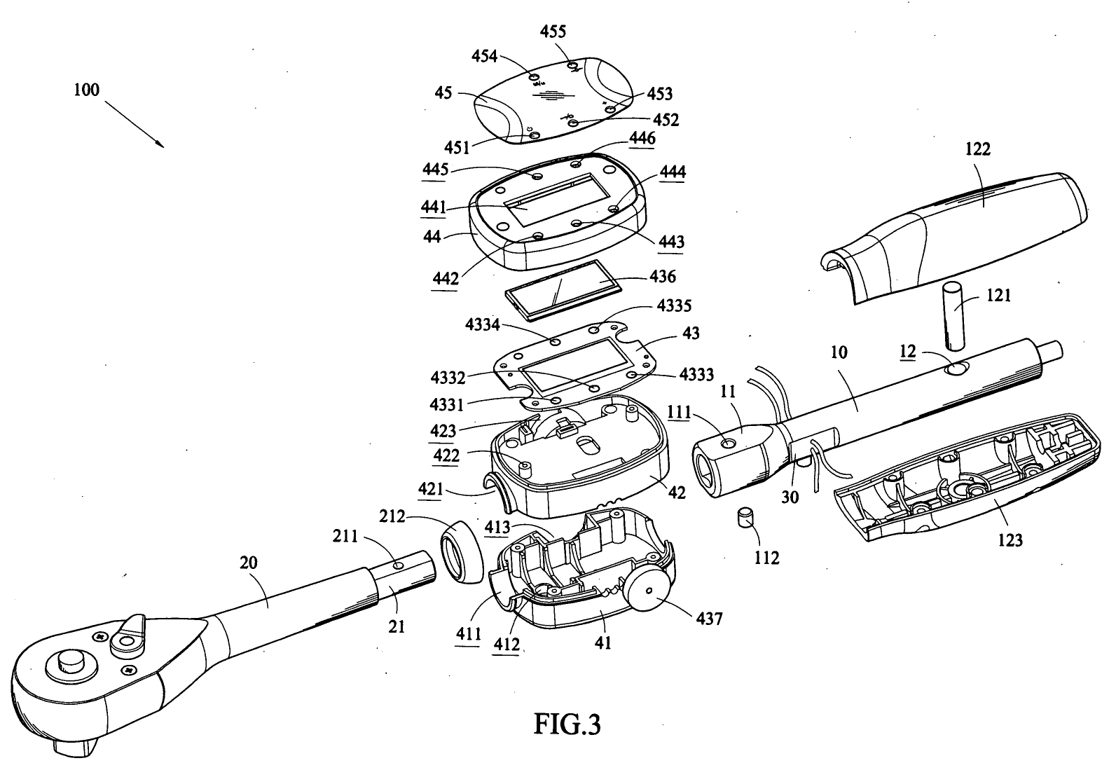

With reference to the drawings and in particular to FIGS. 1-3, a torque wrench constructed in accordance with a first embodiment of the present invention, generally designated with reference numeral 100, is illustrated. The wrench 100 comprises a handle 10, a wrenching unit 20 and at least one torque sensor 30, and a torque display unit 40. The handle 10 has an end forming a connection portion 11, which is not limited to any specific type and configuration, and is embodied as a socket defined by a surrounding wall. Aligned holes 111 are defined in the wall of the socket 11 and on upper and lower sides of the socket as viewed in the drawings. A through hole 12 is formed in the handle 10 at a location close to an opposite end thereof. A dwell pin 121 is fit in the through hole 12 and has upper and lower ends coupled to upper and lower casing members 122, 123 to secure the casing members 122, 123 to the handle 10 for housing the handle 10 between the casing members 122, 123 and allowing hand holding by a user to apply force thereto.

The wrenching unit 20 has an end forming a fitting portion 21 through which a hole 211 is defined. A protective cap 212 is fit over the fitting portion 21. The fitting portion 21 is not limited to any specific type or configuration, and is embodied as a stem in the embodiment illustrated. The fitting portion 21 is configured to correspond to the connection portion 11 of the handle 10 and can be fit therein with the hole 211 aligned with the holes 111 of the connection portion 11 of the handle 10 and the protective cap 212 set at the interface between the fitting portion 21 and the connection portion 11. The wrenching unit 20 is not limited to any specific type and configuration and can be for example a ratchet-based spanner or a gear-operated spanner.

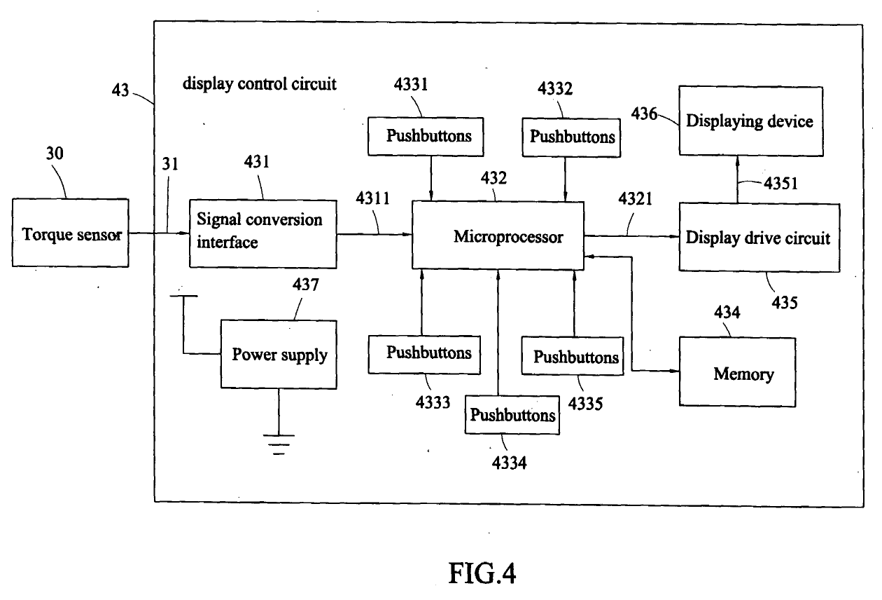

The torque sensor 30 is mounted to the handle 10, and functions to detect deformation/strain occurring in the handle 10 and generates a corresponding detection signal. Thus, the torque sensor 30 can generate a detection signal 31 (see FIG. 4) in accordance with a torque that the handle 10 applies to the wrenching unit 20.

The torque display unit 40 comprises a lower casing member 41, an intermediate casing member 42, a display control circuit 43, an upper casing 44, and a light-transmitting cover panel 45. The lower casing member 41 and the intermediate casing member 42 are combined to house the joint between the fitting portion 21 of the wrenching unit 20 and the connection portion 11 of the handle 10 with the intermediate casing member 42 located above the lower casing member 41 in the view of the drawings. The lower casing member 41 forms an arcuate cut-out 411 at an end thereof and also forms a through hole 412 closed to the end. The intermediate casing member 42 forms at an end thereof an arcuate cut-out 421 and an internally threaded hole 412 at a location close to that end and corresponding to the through hole 412 of the lower casing member 41. The arcuate cut-outs 411, 421 mate each other to form an opening for engaging and retaining the protective cap 121 and also for the extension of the fitting portion 21 of the wrenching unit 20 (and/or the connection portion 11 of the handle 10). The through 412 and the threaded hole 422 are aligned with the holes 111 to receive the extension of a bolt 112 therethrough, to thereby releasably secure these parts together, and allowing the wrenching unit 20 and the handle 10 to be replaceable. In other words, the handle 10, the wrenching unit 20, the lower casing 41 and the intermediate casing member 42 are extended through and secured together by the bolt 112 so that the handle 10, the wrenching unit 20, the lower casing member 41, and the intermediate casing member 42 are fixed together as a unitary device. Similarly, by releasing the bolt 112, the handle 10, the wrenching unit 20, the lower casing 41 and the intermediate casing member 42 are separated. The lower casing member 41 forms a chamber 413, and the intermediate casing member 42 forms a similar chamber 423.

Also referring to FIG. 4, an embodiment of the display control circuit 43 is illustrated. This is for demonstration of operation and practice of the display control circuit 43, rather than limiting the scope of the present invention. The display control circuit 43 is mounted to a top face of the intermediate casing member 42, and comprises a signal conversion interface 431, a microprocessor 432, pushbuttons 4331-4335, a memory 434, a display drive circuit 435, a displaying device 436, and a power supply 437. The signal conversion interface 431 is connected to the torque sensor 30 to receive the detection signal 31 and converts the detection signal 31 into a corresponding digital torque signal 4311.

The microprocessor 432 is connected to the signal conversion interface 431 to receive the digital torque signal 4311 and, in response thereto, supplies a torque display signal 4321 corresponding to the digital torque signal 4311.

The pushbuttons 4331-4335 are coupled to the microprocessor 432 and respectively provide displaying associated functions related to power supply, brightness, storage, and switching of unit of readings. The pushbuttons 4331-4335 allow a user to enter display control signals to the microprocessor 432 in order to cause the microprocessor 432 to carry out operation and display of readings of torque.

The memory 434 is connected to the microprocessor 432 to store readings and/or data of torque detected.

The display drive circuit 435 is connected to the microprocessor 432 to receive the torque display signal 4321 from the microprocessor 432 and the display drive circuit 435, in response to the receipt of the signal 4321, supplies a display drive signal 4351.

The displaying device 436 is connected to the display drive circuit 435 to receive the display drive signal 4351 for displaying of the torque readings on the displaying device 436. The displaying device 436 is not limited to any specific type and can be for example a liquid crystal display. Other displays, such as a light-emitting diode base display, can also be used.

The power supply 437 supplies powers, such as DC powers, to the signal conversion interface 431, the microprocessor 432, the pushbuttons 4331-4335, the memory 434, the display drive circuit 435, and the displaying device 436. The power supply 437 is accommodated and fixed in the chambers 413, 423 of the lower and intermediate casing members 41, 42. The power supply 437 is not limited to any specific type and can be for example a DC battery set.

The upper casing member 44 is mounted atop the intermediate casing member 42 to enclose the display control circuit. The upper casing member 44 forms a display window 441 and pushbutton openings 442-446 to expose the displaying device 436 and the pushbuttons 4331-4335 of the display control circuit 43, respectively.

The light-transmitting cover panel 45 is mounted to a surface of the upper casing member 44 and is provided with indication marks 451-455 respectively associated with the pushbuttons 4331-4335 exposed on the surface of the upper casing member 44.

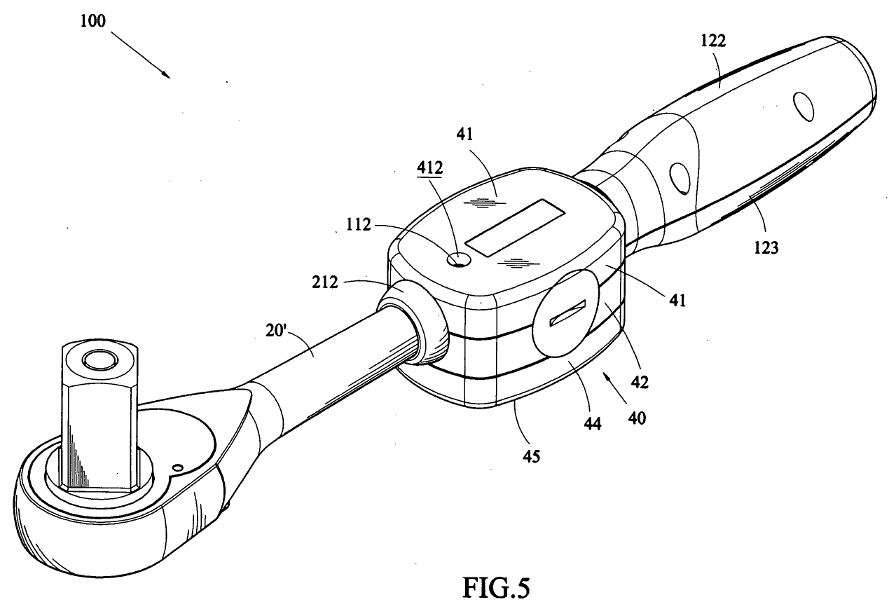

Also referring to FIG. 5, a torque wrench constructed in accordance with a second embodiment of the present invention, also designated with 100 for simplicity, is shown. In the second embodiment, the torque wrench is modified by replacing the wrenching unit 20 with a replacement wrenching unit 20′ that is different from the wrenching unit 20 and the replacement is done by loosening the bolt 112 to separate the handle 10, the wrenching unit 20, the lower casing member 41, and the intermediate casing member 42. The replacement wrenching unit 20′ can be of different specifications for operation with different types and specifications of bolts/screws. It is noted that the readings of torque for different operations can be stored in the display control circuit 43.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A torque wrench comprising:
a handle having an end forming a connection portion;
a wrenching unit having an end forming a fitting portion, which is connectable with the connection portion of the handle;
at least one torque sensor mounted to the handle to detect deformation of the handle and, in response thereto, generate a detection signal corresponding to a torque that the handle applies to the wrenching unit; and
at least one torque display unit, coupled to a joint between the connection portion of the handle and the fitting portion of the wrenching unit and connected to the torque sensor to receive the detection signal and further process and convert the detection signal to display a reading of the torque that the handle applies to the wrenching unit.

2. The torque wrench as claimed in claim 1, wherein the connection portion of the handle comprises a socket.

3. The torque wrench as claimed in claim 1, wherein the socket of the connection portion is delimited by a surrounding wall through which aligned holes are defined.

4. The torque wrench as claimed in claim 1, wherein the handle forms a through hole.

5. The torque wrench as claimed in claim 4, wherein the handle comprises a pin received and fixed in the through hole.

6. The torque wrench as claimed in claim 5, wherein the pin has upper and lower ends coupled to upper and lower handle casing members respectively.

7. The torque wrench as claimed in claim 1, wherein the wrenching unit comprises a torque wrench.

8. The torque wrench as claimed in claim 1, wherein the fitting portion of the wrenching unit comprises a stem.

9. The torque wrench as claimed in claim 1, wherein the fitting portion of the wrenching unit forms a hole.

10. The torque wrench as claimed in claim 1, wherein the torque display unit comprises:
a lower casing member arranged at a joint between the fitting portion of the wrenching unit and a connection portion of the handle;
an intermediate casing member mounted to the lower casing member to enclose the joint between the fitting portion of the wrenching unit and a connection portion of the handle;
a display control circuit mounted to the intermediate casing member, the display control circuit connected to the torque sensor to receive the detection signal and, in response thereto, generating a corresponding reading of the torque;
an upper casing member mounted to the intermediate casing member to cover the display control circuit; and
a light-transmitting cover panel mounted to a surface of the upper casing member.

11. The torque wrench as claimed in claim 10, wherein the lower casing member forms a first arcuate cut-out.

12. The torque wrench as claimed in claim 10, wherein the lower casing member forms a through hole.

13. The torque wrench as claimed in claim 10, wherein the intermediate casing member forms a second arcuate cut-out.

14. The torque wrench as claimed in claim 10, wherein the intermediate casing member forms an internally-threaded hole.

15. The torque wrench as claimed in claim 10, wherein the display control circuit comprises:
a signal conversion interface connected to the torque sensor to receive the detection signal and convert the detection signal into a corresponding digital torque signal;
a microprocessor connected to the signal confession interface to receive the digital torque signal and generates, in response thereto, a torque display signal;
a plurality of pushbuttons coupled to the microprocessor to enter display control signals to the microprocessor in order to cause the microprocessor to carry out corresponding operations associated with torque reading displaying;
a memory connected to the microprocessor to store data of the torque reading;
a display drive circuit connected to the microprocessor to receive the torque display signal from the microprocessor and, in response thereto, supplying a display drive signal;
a displaying device connected to the display drive circuit to receive the display drive signal to display the torque reading; and
a power supply supplying operation powers to the signal conversion interface, the microprocessor, the pushbuttons, the memory, the display drive circuit, and the displaying device.

16. The torque wrench as claimed in claim 15, wherein the displaying device comprises a liquid crystal display.

17. The torque wrench as claimed in claim 15, wherein the power supply comprises a DC battery set.
